(19) United States
(12) Patent Application Publication
(10) Pub. No.: US 2013/0208363 A1
(43) Pub. Date: Aug. 15, 2013

(54) DISPLAY DEVICE FOR VEHICLE

(71) Applicant: YAZAKI CORPORATION, (US)

(72) Inventor: Akira MASUDA, Shimada-shi (JP)

(73) Assignee: YAZAKI CORPORATION, Tokyo (JP)

(21) Appl. No.: 13/755,055

(22) Filed: Jan. 31, 2013

(30) Foreign Application Priority Data
Feb. 10, 2012 (JP) 2012-027523

(51) Int. Cl. G02B 27/01

(52) U.S. Cl. CPC G02B 27/0101
USPC 359/630

(57) ABSTRACT

A display device for a vehicle is provided which can efficiently transmit lights from a light source to improve a visibility of a display. In a head up display device, a combiner having a light transmission property is fixed to an upper part of a display device main body, and display lights outputted form the display device main body are projected on the combiner. The display device main body includes a light source, a lens array on which lights of the light source are converged and an LCD panel which transmits the lights converged on the lens array to have the display lights. Each of lens parts of the lens array has an output side and an incident side of the lights formed respectively as an output convex lens surface and an incident convex lens surface which respectively bulge in protruding forms.

### BACKGROUND OF THE INVENTION

The present invention relates to a display device for a vehicle in which a virtual image is projected on a combiner to visually recognize the virtual image from an eye point of the vehicle.

In recent years, as information required when a driver drives a vehicle is more increased and versatile, a display device for a vehicle such as a head up display (HUD: Head Up Display) device is mounted on a motor vehicle or a train which displays especially information high in its emergency to be visually recognized the information by displaying a virtual image on a combiner.

As the display device for the vehicle of this kind, a display device is known in which a display image of a display device is projected on a combiner formed with a light guide member (for instance, patent literature 1).

### CITATION LIST

### [Patent Literature 1] JP-UM-A-2-59027

The display device in which the virtual image is displayed by projecting the virtual image on the combiner formed with the light guide member and having a light transmission property so as to visually recognize the virtual image, as in the above-described display device for the vehicle, is liable to receive an influence from outer lights. Accordingly, in the display device for the vehicle in which the virtual image is displayed on the combiner having the light transmission property, it is necessary to efficiently transmit display lights from the display device and apply the display lights on the combiner with a high light emission luminance.

### SUMMARY

The present invention is devised by considering the above-described circumstances and it is an object of the present invention to provide a display device for a vehicle which can efficiently transmit lights from a light source and improve a visibility of a display.

The object of the invention is accomplished by the configuration provided below.

(1) A display device for a vehicle, comprising a display device main body and a combiner having a light transmission property, the combiner being fixed to an upper part of the display device main body and display lights outputted from the display device main body being projected on the combiner,

the display device main body including a light source, a lens member on which lights of the light source are converged, and a display configured to transmit the lights converged on the lens member to have the display lights,

wherein the lens member has an output side and an incident side of the lights respectively formed as convex lens surfaces which bulge in protruding shapes.

(2) A display device for a vehicle according to claim 1, wherein the lens member has the output side and the incident side respectively having the convex lens surfaces whose curvatures are different from each other.

In the display device for the vehicle having the structure of the above-described (1), the output side and the incident side of the lights in the lens member on which the lights of the light source are converged are respectively formed in the convex lens surfaces which respectively bulge in the protruding forms.

Thus, the lights from the light source can be guided stepwise and reasonably in a prescribed direction by the convex lens surfaces of the incident side and the output side with a good directivity. Further, since the incident lights are bent toward the output side by the incident convex lens surface of the incident side, the lights which are scattered in a periphery when the incident side is formed in a plane can be captured and efficiently converged to the output side. Thus, the lights of the light source can be transmitted to the prescribed direction without wastefulness.

Accordingly, the luminance of the display lights with which the combiner is irradiated can be improved as much as possible. A display can be effectively projected on the combiner having a light guide property to improve a visibility.

In the display device for the vehicle having the structure of the above-described (2), since the curvature of the convex lens surface of the output side of the lens member is made to be different from the curvature of the convex lens surface of the incident side, an optical path of the lights of the light source can be easily and efficiently directed to a proper direction. Further, when the curvatures of the convex lens surfaces of the output side and the incident side are adjusted, a quantity of light to be outputted can be adjusted.

As mentioned above, the present invention is briefly described. When Mode for Carrying Out the Invention that will be described below is read by referring to the attached drawings, a detail of the present invention will be more clarified.

### BRIEF DESCRIPTION OF THE DRAWINGS

FIG. 1 is a perspective view of a head up display device according to an exemplary embodiment.

FIG. 2 is a sectional view of the head up display device according to the exemplary embodiment.

FIG. 3 is an exploded perspective view of the head up display device according to the exemplary embodiment.

FIG. 4 is an enlarged sectional view of a lens array and a periphery thereof in a display device main body.

### DETAILED DESCRIPTION OF EMBODIMENTS

Now, an exemplary embodiment of the present invention will be described below by referring to the drawings.

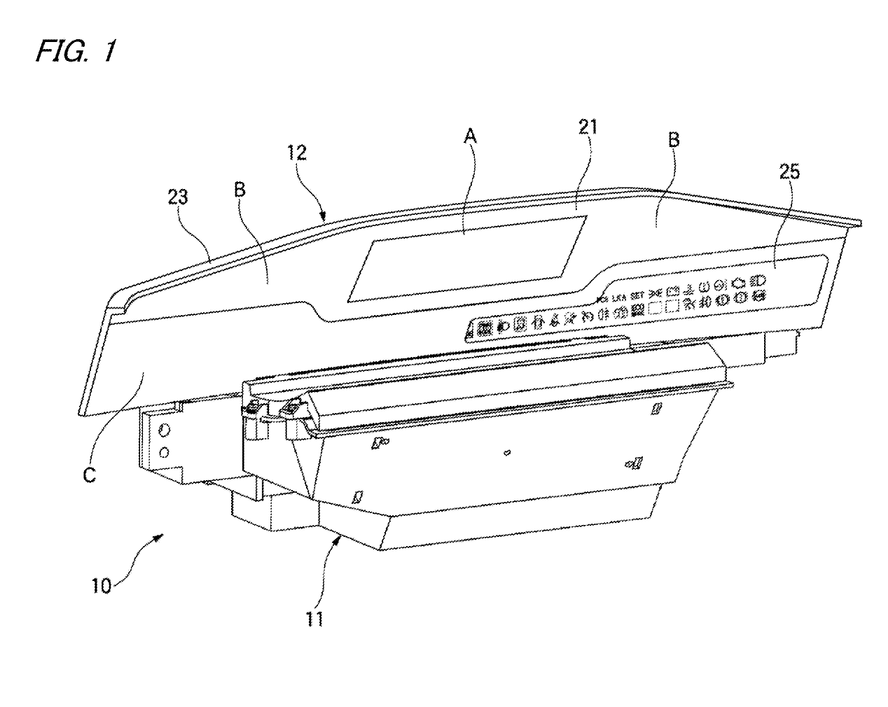

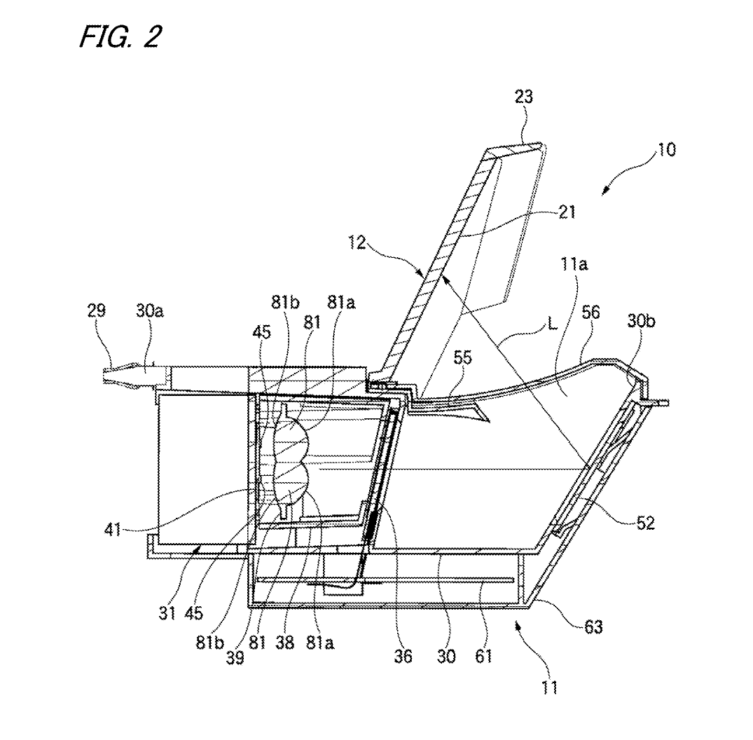

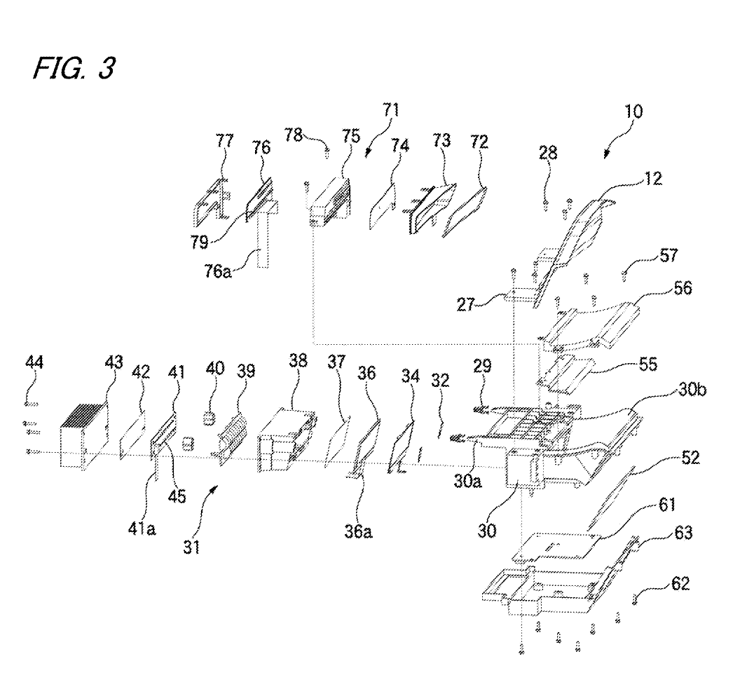

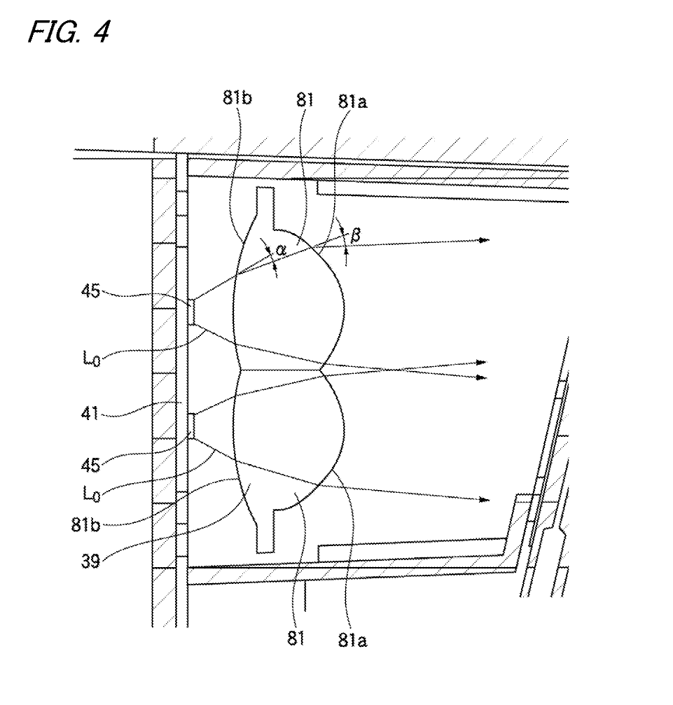

FIG. 1 is a perspective view of a head up display device according to an exemplary embodiment. FIG. 2 is a sectional view of the head up display device according to the exemplary embodiment. FIG. 3 is an exploded perspective view of the head up display device according to the exemplary embodiment. FIG. 4 is an enlarged sectional view of a lens array and a periphery thereof in a display device main body.

As shown in FIG. 1, the head up display device 10 as a display device for a vehicle according to the present exemplary embodiment includes a display device main body 11 and a combiner 12 fixed to an upper part of the display device main body 11.

The display device main body 11 is accommodated in a dashboard of the vehicle and display lights are applied to the combiner 12 from the display device main body 11.

The combiner 12 is arranged on the dashboard of the vehicle and irradiated with the display lights from the display device main body 11. Thus, a virtual image is projected on the combiner 12. The virtual image is visually recognized from an eye point of a driver of the vehicle.

The combiner 12 is molded with a synthetic resin and has a light transmitting part 21 with a light transmission property. The light transmitting part 21 has a central part set as a display area A on which the display lights are applied from the display device main body 11 to form the virtual image. This virtual image is a display of information such as a travel speed of the vehicle, a residual quantity of fuel or a battery or temperature of a driving mechanism part.

Further, in the light transmitting part 21 of the combiner 12, both sides as outer sides of the display area A are formed as transparent transmitting parts B. The transparent transmitting part B is formed as an area which can be recognized to be transparent when the area B is visually observed.

A lower part of the combiner 12 as a lower side of the light transmitting part 21 having the display area A and the transparent transmitting parts B in the combiner 12 is formed as a colored area C which is darkened in a direction of width. The colored area C is colored in black in the direction of width by, for instance, printing or painting. Further, in an upper part of the light transmitting part 21 of the combiner 12, a hood part 23 which protrudes toward a side irradiated with the display lights is integrally formed along an upper edge. The hood part 23 is colored in, for instance, black. The hood part 23 is formed by a bicolor molding by the use of a black resin when the combiner 12 is formed.

Since the combiner 12 is provided with the black colored area C and the black colored hood part 23, an influence of outer lights is suppressed to the display of the information projected on the display area A. Further, the outer lights are restrained from being reflected and applied to an indoor side of the vehicle.

The color of the colored area C and the hood part 23 is not limited to black, and, dark color such as dark gray may be used.

Further, in the colored area C of the combiner 12, a display part 25 which displays an image is provided in a part thereof. In the display part 25, a sub-display such as various kinds of warnings is indicated.

Now, a specific structure of the head up display device 10 will be described below.

As shown in FIG. 2 and FIG. 3, the display device main body 11 forming the head up display device 10 has a case 30 formed with a synthetic resin.

In the combiner 12, connecting stays 27 which extend in a horizontal direction are integrally formed near both side parts in a lower end thereof. The connecting stays 27 are connected to the display device main body 11 by screws 28. Thus, the combiner 12 is fixed to the upper part of the display device main body 11. A fixing structure of the combiner 12 to the display device main body 11 is not limited to a structure that the connecting stays 27 are fastened and fixed by the screws 28 and other structure may be used. Further, connecting positions of the combiner 12 to the display device main body 11 are not limited to parts near both the side parts of the combiner 12.

Further, in the case 30, vehicle body attaching parts 30a are formed to protrude forward. The vehicle body attaching parts 30a are held on a bracket in the dashboard by clips 29.

To the case 30, an image forming assay 31 is attached. The image forming assay 31 includes a turn lens 32, a shield case 34, an LCD panel 36, a diffusing sheet 37, a back light case 38, a lens array 39, a turn prism 40, a back light base board 41, a heat transfer sheet 42 and a heat sink 43. These members are attached in order to the case 30 and fixed to the case 30 by screws 44.

In the image forming assay 31, lights emitted in a light source 45 such as an LED provided in the back light base board 41 are converged on the lens array 39, diffused by the diffusing sheet 37 and applied to the LCD panel 36. Thus, an image of the LCD panel 36 is applied to the case 30 as display lights L.

To the case 30, a plane mirror 52 is attached in a front side in the direction where the display lights L are applied. The plane mirror 52 reflects the display lights L applied from the image forming assay 31 toward an opening part 30b side of an upper part of the case 30. Further, to the opening part 30b of the upper part of the case 30, a light shield plate 55 and a front glass 56 are fixed by screws 57. The opening part 30b closed by the front glass 56 is formed as an output port 11a of the display lights L applied toward the combiner 12.

Further, in the case 30, a control base board 61 is attached to a bottom part side thereof. The control base board 61 is covered with a cover 63 fixed to the bottom part of the case 30 by screws 62. To the control base board 61, are connected connecting cables 36a and 41a extending from the LCD panel 36 and the back light base board 41.

As shown in FIG. 4, the lens array 39 forming the image forming assay 31 has lens parts 81 corresponding to the light sources 45 provided in the back light base board 41. In the lens parts 81, light source 45 sides are set as incident sides of lights Lo from the light sources 45 and opposite sides to the light sources 45 are set as output sides of the incident lights Lo.

In the lens part 81, the output side and the incident side are respectively formed in an output convex lens surface 81a and an incident convex lens surface 81b which respectively bulge in protruding forms. A curvature of the output convex lens surface 81a is different from that of the incident convex lens surface 81b. Specifically, the curvature of the incident convex lens surface 81b is set to be smaller than the curvature of the output convex lens surface 81a.

In the above-described lens array 39, the lights Lo from each of the light sources 45 are bent at a small angle of refraction α in a direction of an optical axis when the lights Lo are incident from the incident convex lens surface 81b of each of the lens parts 81. Then, in the output convex lens surface 81a, the lights Lo are bent at an angle of refraction β larger than the angle of refraction a in the incident convex lens surface 81b in the direction of the optical axis and outputted.

As described above, in the lens array 39, the lights from the light source 45 are reasonably guided in the direction along the optical axis in the incident convex lens surface 81b and the output convex lens surface 81a and applied to the LCD panel 36 side.

As shown in FIG. 2 and FIG. 3, to a back surface side of the colored area C of the combiner 12 in the case 30 of the display device main body 11, a display part assay 71 forming the display part 25 is attached.

The display part assay 71 includes a rubber packing 72, a facing frame 73, a lens plate 74, a lamp case 75, a displaying board 76 and a display part case 77. These members are attached in order to the combiner 12 side and fixed to the case 30 by screws 78. Further, from the displaying board 76, a connecting cable 76a is extended downward. The connecting cable 76a is also connected to the control base board 61.

In the display part assay 71, lights emitted in a light source 79 such as an LED provided in the displaying board 76 are applied to the combiner 12 side through the lens plate 74, so that an image is formed on the combiner 12. Thus, the sub-display is indicated on the display part 25 of the combiner 12.

In the head up display device 10 having the above-described structure, the display lights L applied from the image forming assay 31 are reflected by the plane mirror 52 in the case 30, then, outputted outside the case 30 from the opening part 30b closed by the front glass 56 of the case 30, applied to the display area A of the combiner 12 and guided to an eye range of the driver.

Thus, the driver can visually recognize the display of the information formed with the virtual image projected on the display area A of the combiner 12 from the eye point of the vehicle.

As described above, in the head up display device as the display device for the vehicle, the output side and the incident side of the lights Lo in each of the lens parts 81 of the lens array 39 on which the lights Lo of the light source 45 are converged are respectively formed in the output convex lens surface 81a and the incident convex lens surface 81b which respectively bulge in the protruding forms.

Thus, the lights Lo from the light source 45 can be guided stepwise and reasonably in a prescribed direction by the incident convex lens surface 81b and the output convex lens surface 81a with a good directivity. Further, since the incident lights Lo are bent toward the output side by the incident convex lens surface 81b, the lights which are scattered in a periphery when the incident side is formed in a plane can be captured and efficiently converged to the output side. Thus, the lights Lo of the light source 45 can be transmitted to the prescribed direction without wastefulness.

Accordingly, the luminance of the display lights L with which the combiner 12 is irradiated can be improved as much as possible. The display can be effectively projected on the combiner 12 having a light guide property to improve a visibility.

Further, since the curvature of the output convex lens surface 81a of each of the lens parts 81 of the lens array 39 is made to be different from the curvature of the incident convex lens surface 81b, an optical path of the lights Lo of the light source 45 can be easily and efficiently directed to a proper direction. Further, when the curvatures of the output convex lens surface 81a and the incident convex lens surface 81b are adjusted, a quantity of light to be outputted can be adjusted.

In the above-described exemplary embodiment, the display lights L from the image forming assay 31 are reflected once on the plane mirror 52 and projected on the combiner 12. However, the display lights L from the image forming assay 31 may be directly projected on the combiner 12, or the display lights L from the image forming assay 31 may be reflected two times or more and projected on the combiner 12.

It is apparent that various modifications can be made in the invention within a scope not deviating from the gist of the invention.

The present application is based on Japanese patent application No. 2012-027523 filed on Feb. 10, 2012, and the contents of the patent application are incorporated herein by reference.

According to the present invention, a display device for a vehicle can be provided which can efficiently transmit lights from a light source to improve a visibility of a display.

What is claimed is:

1. A display device for a vehicle, comprising a display device main body and a combiner having a light transmission property, the combiner being fixed to an upper part of the display device main body and display lights outputted from the display device main body being projected on the combiner,
the display device main body including a light source, a lens member on which lights of the light source are converged, and a display configured to transmit the lights converged on the lens member to have the display lights,
wherein the lens member has an output side and an incident side of the lights respectively formed as convex lens surfaces which bulge in protruding shapes.

2. A display device for a vehicle according to claim 1, wherein the lens member has the output side and the incident side respectively having the convex lens surfaces whose curvatures are different from each other.
